(19) United States
(12) Patent Application Publication
(10) Pub. No.: US 2011/0221275 A1
(43) Pub. Date: Sep. 15, 2011

(54) High output impedance current source

(76) Inventor: Munir A. Al-Absi, Dhahran (SA)

(21) Appl. No.: 12/659,577

(22) Filed: Mar. 12, 2010

(51) Int. Cl. G05F 3/16

(52) U.S. Cl. 307/52

(57) ABSTRACT

The high output impedance current source utilizes an opto-coupler integrated circuit to provide a high output impedance, regulated current to a load. The circuit includes an initial voltage source for energizing an LED. The light intensity of the LED is controlled by varying the voltage source or by a separate resistor. The LED selectively controls on-off gating of a phototransistor. The current supplied to an electrical load is a function of the light intensity produced by the LED, thus also being a function of the controlled initial voltage. The emitter of the phototransistor is connected to its base, thus making the output resistance of the current source very high and equal to that of a reverse-biased diode as long as the collector-to-base junction remains in the reverse-biased mode. The high output impedance current source can also be used as a voltage-to-current converter.

### BACKGROUND OF THE INVENTION

1. Field of the Invention

The present invention relates to current regulation circuitry, and more specifically to a high output impedance current source circuit that uses an opto-coupler.

2. Description of the Related Art

Current sources are used in many applications, such as process control, instrumentation, bioinstrumentation, and the like. In such applications the device sinking the current may vary widely in its load impedance. It would be desirable to deliver a constant current regardless of such a widely varying load impedance. For example, it would be advantageous to be able to vary a device load impedance from 1Ω to 10 MΩ while still keeping the current at a constant value. Thus, the output current as a function of the load resistance is ideally a flat line. Moreover, the load should preferably be larger when the current supplied is small.

Thus, a high output impedance current source solving the aforementioned problems is desired.

### SUMMARY OF THE INVENTION

The high output impedance current source utilizes an opto-coupler integrated circuit to provide a high output impedance, regulated current to a load. The circuit includes an initial voltage source for energizing an LED. The light intensity of the LED is controlled by varying the voltage source or by a separate resistor. The LED selectively controls on-off gating of a phototransistor. The current supplied to an electrical load is a function of the light intensity produced by the LED, thus also being a function of the controlled initial voltage. The emitter of the phototransistor is connected to its base, thus making the output resistance of the current source very high and equal to that of a reverse-biased diode as long as the collector-to-base junction remains in the reverse-biased mode. This high output impedance current source can also be used as a voltage-to-current converter.

These and other features of the present invention will become readily apparent upon further review of the following specification and drawings.

### BRIEF DESCRIPTION OF THE DRAWINGS

FIG. 1 is a schematic diagram showing the electronic circuit of a high output impedance current source according to the present invention.

FIG. 2 is a schematic diagram showing the resistance evaluation model of a high output impedance current source according to the present invention.

FIG. 3 is a plot showing current as a function of load resistance for the high output impedance current source according to the present invention.

Similar reference characters denote corresponding features consistently throughout the attached drawings.

### DETAILED DESCRIPTION OF THE PREFERRED EMBODIMENTS

As shown in FIG. 1, the high output impedance current source is a low cost, very high output impedance current source 10. The high output impedance current source 10 is variable and can produce DC current down to the pico-ampere range.

The high output impedance current source 10 uses an existing opto-coupler integrated circuit 25, such as the Fairchild Semiconductor® MCT2, or, alternatively, a germanium-type LED, to provide a high output impedance, regulated current to a load 35.

The voltage V1 is used to turn on or activate the light emitting diode (LED) 29 built into the opto-coupler. The light intensity produced is a function of the current I₁ passing through the LED 29. Light intensity of the LED 29 can be controlled by the voltage V1 of the DC voltage source 15 or by the value of the resistor 20 (R₁), which is connected between the positive terminal of the DC source 15 and the anode of the LED diode 29.

Light emitted by the LED diode 29 is used to switch the NPN phototransistor portion of the opto-coupler integrated circuit 25 in a controllable way. The current I_{L} supplied to the load 35 is a function of the light intensity produced by the LED 29 and, hence, a function of the controlled voltage V₁. The current flow in the direction of I_{L} is facilitated, since the base 30a is connected to the emitter 30b. The negative terminal of the voltage source 15 is connected to ground. The terminals of the load resistance 35 (RL) are connected between the node formed by the connectivity of the emitter 30b to the base 30a and ground. Positive voltage VCC connected to the collector 31 helps to maintain the reverse-bias diode configuration of the junction formed by the collector 31 and the base 30a.

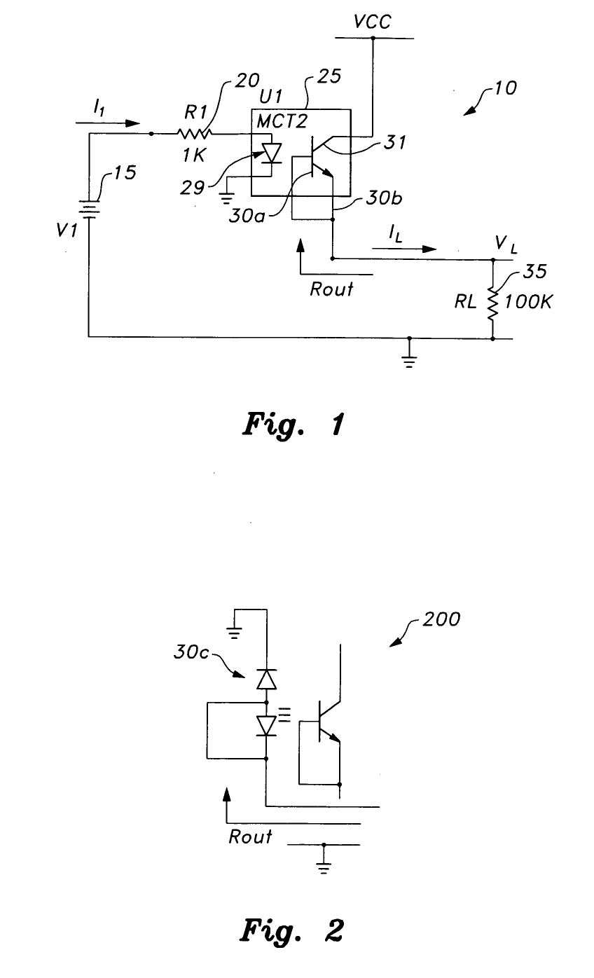

As shown in FIG. 2, a model 200 of the current source 10 reveals that the output resistance of the current source, Rₒᵤₜ is very high and equal to that of a reverse-biased diode 30c, which corresponds to the junction of the collector 31 with the base 30a shown in FIG. 1.

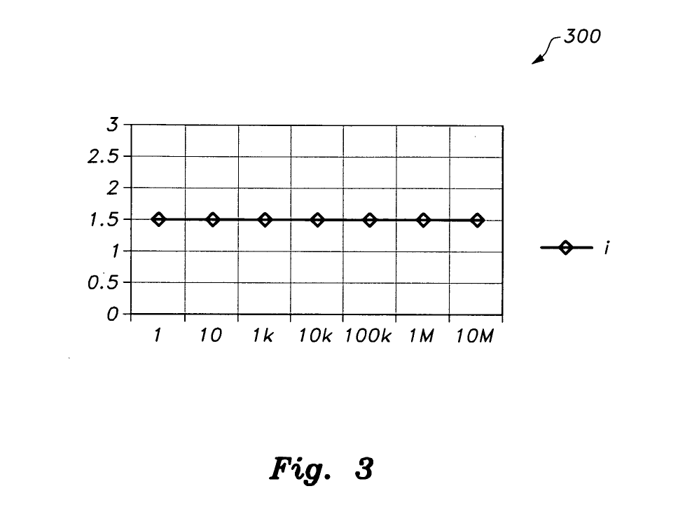

Verification of the circuit was carried out by simulation and confirmed by experimental prototype testing. The load was varied from 1Ω to 10 MΩ, and the current remained constant. The plot 300 of the output current as a function of the load resistance, as shown in FIG. 3, reveals that the load can be larger if the current supplied is small. Thus, preferably, the load voltage should be kept smaller than VCC so that the PN junction 30c between the collector and the base remains in reverse-biased mode.

It is to be understood that the present invention is not limited to the embodiment described above, but encompasses any and all embodiments within the scope of the following claims.

I claim:

1. A high output impedance current source, comprising:
an opto-coupler having a light source optically coupled to a bipolar phototransistor having a collector, base, and emitter, the base being directly connected to the emitter to form a base-emitter node, the collector and the base forming a reverse-biased junction;
a first voltage source connected to the light source, the first voltage source activating the light source; and
a second voltage source connected to the collector of the phototransistor, the second voltage source facilitating the reverse-biased state of the collector-base junction;
wherein when a load is connected between the base-emitter node and ground, the opto-coupler pumps a constant load current through the load independent of fluctuations in impedance of the load.

2. The high output impedance current source according to claim 1, wherein said opto-coupler light source comprises an LED and said phototransistor comprises an NPN transistor.

3. The high output impedance current source according to claim 1, wherein said load current remains constant under a load impedance that varies between 1 ohm and 10 megohm.

4. The high output impedance current source according to claim 1, wherein output impedance of the high output impedance current source is approximately equal to impedance presented by the reverse-biased junction formed by the collector and the base due to connection of said second voltage source to the collector of said photoreceptive transistor.
